(19) United States
(12) Patent Application Publication
(10) Pub. No.: US 2025/0118878 A1
(43) Pub. Date: Apr. 10, 2025

(54) CELL STACK ASSEMBLY AND BATTERY MODULE

(71) Applicant: TOYOTA JIDOSHA KABUSHIKI KAISHA, Toyota-shi (JP)

(72) Inventors: Yusuke IKEDA, Miyoshi-shi (JP); Kenichi KAKISHITA, Nagoya-shi (JP); Tomofumi HIRUKAWA, Miyoshi-shi (JP); Masashi UEDA, Toyota-shi (JP); Shinji KOJIMA, Nagoya-shi (JP); Masataka OGUSHI, Nisshin-shi (JP); Kosuke YONEKAWA, Nisshin-shi (JP)

(73) Assignee: TOYOTA JIDOSHA KABUSHIKI KAISHA, Toyota-shi (JP)

(21) Appl. No.: 18/810,621

(22) Filed: Aug. 21, 2024

(30) Foreign Application Priority Data
Oct. 10, 2023 (JP) 2023-175532

(51) Int. Cl. H01M 50/595; H01M 50/249

(52) U.S. Cl. CPC H01M 50/595; H01M 50/249

(57) ABSTRACT

A cell stack assembly, including: a plurality of stacked battery cells, each including an electrode assembly; a laminate exterior packaging that covers the electrode assembly and encloses the electrode assembly internally; and a fixing tape, including at least one of an inner fixing tape wound in a peripheral direction onto an outer peripheral face of the electrode assembly at an inner side of the laminate exterior packaging, or an outer fixing tape wound in a peripheral direction onto an outer peripheral face of the laminate exterior packaging, wherein: taking a direction in which the plurality of battery cells are stacked as a stacking direction, the fixing tape is wound such that winding positions of the fixing tape do not overlap in the stacking direction for at least one adjacent pair of the battery cells.

### CROSS-REFERENCE TO RELATED APPLICATION

This application is based on and claims priority under 35 USC 119 from Japanese Patent Application No. 2023-175532 filed on Oct. 10, 2023, the disclosure of which is incorporated by reference herein.

### BACKGROUND

### Technical Field

The present disclosure relates to a cell stack assembly and a battery module.

### Related Art

Research has hitherto been performed into a battery cell in which plural electrode assemblies, each configured by a cathode, an anode, and a separator together, are stacked and bundled together using tape.

For example, Japanese Patent Application Laid-Open (JP-A) No. 2016-15212 discloses a secondary battery including a stack assembly of alternately stacked cathodes and anodes with separators interposed therebetween, and including tape to fix the stack assembly. The tape includes one pair of flat surface stuck portions that are provided at two end portions and are respectively stuck to the two outermost layers of the stack assembly, and an intermediate portion that is positioned between the pair of flat surface stuck portions and is stuck to a side end edge of each layer of the stack assembly. The flat surface stuck portions have a taper shape with an acute angle at a leading end thereof.

Hitherto, fixing has been performed by winding fixing tape onto electrode assemblies configuring a battery and onto a laminate exterior packaging that covers the electrode assemblies. Examples of the fixing tape include an inner fixing tape wound onto an outer peripheral face of the electrode assemblies at the inner side of the laminate exterior packaging, and an outer fixing tape wound onto an outer peripheral face of the laminate exterior packaging. However, when the fixing tape has been wound this results in an increase in thickness by the amount of the fixing tape, and there is accordingly room for improvement in raising volumetric efficiency.

### SUMMARY

The present disclosure provides a cell stack assembly having higher volumetric efficiency, and a battery module including such a cell stack assembly.

A cell stack assembly of a first aspect of the present disclosure is a cell stack assembly including plural stacked battery cells. Each of the battery cells includes an electrode assembly, a laminate exterior packaging that covers the electrode assembly and encloses the electrode assembly internally, and a fixing tape, including at least one of an inner fixing tape wound in a peripheral direction onto an outer peripheral face of the electrode assembly at an inner side of the laminate exterior packaging, or an outer fixing tape wound in a peripheral direction onto an outer peripheral face of the laminate exterior packaging. Taking a direction in which the plural battery cells are stacked as a stacking direction, the fixing tape is wound such that winding positions of the fixing tape do not overlap in the stacking direction for at least one adjacent pair of the battery cells.

A cell stack assembly of a second aspect of the present disclosure is the cell stack assembly of the first aspect, wherein the fixing tape includes only the inner fixing tape, and the inner fixing tape is wound such that winding positions of the inner fixing tape do not overlap in the stacking direction for at least one adjacent pair of the battery cells.

A cell stack assembly of a third aspect of the present disclosure is the cell stack assembly of the first aspect, wherein the fixing tape includes only the outer fixing tape, and the outer fixing tape is wound such that winding positions of the outer fixing tape do not overlap in the stacking direction for at least one adjacent pair of the battery cells.

A cell stack assembly of a fourth aspect of the present disclosure is the cell stack assembly of the first aspect, wherein the fixing tape includes the inner fixing tape and the outer fixing tape, and the inner fixing tape and the outer fixing tape are wound such that winding positions of the inner fixing tape and winding positions of the outer fixing tape do not overlap in the stacking direction for at least one adjacent pair of the battery cells.

A cell stack assembly of a fifth aspect of the present disclosure is the cell stack assembly of the fourth aspect, wherein the fixing tape is wound such that winding positions of the inner fixing tape and winding positions of the outer fixing tape do not overlap in a single battery cell of the battery cells.

A cell stack assembly of a sixth aspect of the present disclosure is the cell stack assembly of any one aspect of the first aspect to the fifth aspect, wherein the fixing tape is wound such that the winding positions of the fixing tape do not overlap in the stacking direction for any of the battery cells that are adjacent to each other.

A cell stack assembly of a seventh aspect of the present disclosure is the cell stack assembly of any one aspect of the first aspect to the sixth aspect, wherein the fixing tape is wound such that the winding positions of the fixing tape do not overlap in the stacking direction for any the battery cells.

A battery module of an eighth aspect of the present disclosure includes a cell stack assembly of any one aspect of the first aspect to the seventh aspect.

The present disclosure is able to provide a cell stack assembly having raised volumetric efficiency, and a battery module including such a cell stack assembly.

### BRIEF DESCRIPTION OF THE DRAWINGS

Exemplary embodiments of the present disclosure will be described in detail based on the following figures, wherein:

FIG. 1 is a schematic perspective view illustrating a single electrode assembly and inner fixing tape of a cell stack assembly according to a first embodiment;

FIG. 2 is a schematic side view illustrating a battery cell in which the single electrode assembly and inner fixing tape illustrated in FIG. 1 have furthermore been enclosed by a laminate exterior packaging;

FIG. 3 is a schematic side view illustrating the cell stack assembly according to a first embodiment;

FIG. 4 is a schematic side view illustrating a battery cell in which a single electrode assembly and a laminate exterior packaging in a cell stack assembly according to a second embodiment have been fixed by outer fixing tape;

FIG. 5 is a schematic side view illustrating a cell stack assembly according to the second embodiment;

FIG. 6 is a schematic side view illustrating a cell stack assembly according to a third embodiment;

FIG. 7 is a schematic side view illustrating a cell stack assembly according to a modified example;

FIG. 8 is a schematic plan view illustrating relevant portions of a vehicle;

FIG. 9 is a schematic perspective view of a battery module;

FIG. 10 is a plan view of a state in which a lid of a battery module has been removed; and

FIG. 11 is a schematic diagram of a battery cell housed in a battery module, as viewed along a thickness direction.

### DETAILED DESCRIPTION

Description follows regarding exemplary embodiments that are examples of the present disclosure. This description and examples are merely for the purpose of illustrating examples of the exemplary embodiments, and do not limit the scope of the invention.

In the stepwise numerical ranges referred to in the present specification, the upper value or the lower value of a given numerical range may be replaced by the upper value or the lower value of another of the stepwise numerical ranges. Moreover, in the numerical ranges referred to in the present specification, the upper value or the lower value of these numerical ranges may be replaced by a value indicated in an example.

A cell stack assembly according to an exemplary embodiment of the present disclosure is a cell stack assembly configured by plural stacked battery cells. These battery cells each include an electrode assembly, a laminate exterior packaging that covers the electrode assembly and encloses the electrode assembly inside, and a fixing tape, including at least one fixing tape from out of an inner fixing tape wound in a peripheral direction around an outer peripheral face of the electrode assembly at the inner side of the laminate exterior packaging or an outer fixing tape wound in the peripheral direction around an outer peripheral face of the laminate exterior packaging.

Taking a direction in which the plural battery cells are stacked as a stacking direction, winding positions of the fixing tapes do not overlap in the stacking direction for at least one pair of battery cells that are adjacent to each other wound with fixing tape.

For example, in cases in which the battery cells include only an inner fixing tape as the fixing tape, the inner fixing tape is wound such that positions where the inner fixing tape is wound do not overlap in the stacking direction for at least one pair of battery cells that are adjacent to each other.

Moreover, in cases in which the battery cells include only outer fixing tapes as the fixing tapes, the outer fixing tape is wound such that positions where the outer fixing tape is wound do not overlap in the stacking direction for at least one pair of battery cells that are adjacent to each other.

Furthermore, in cases in which the battery cells include both inner fixing tapes and outer fixing tapes as the fixing tapes, the inner fixing tapes and the outer fixing tapes are wound such that all of the winding positions of the outer fixing tapes and all of the winding positions of the inner fixing tapes do not overlap in the stacking direction for at least one pair of battery cells that are adjacent to each other.

Hitherto cell stack assemblies have been employed in batteries, with each cell including an electrode assembly and a laminate exterior packaging covering the electrode assembly, and the electrode assemblies and the laminate exterior packagings stacked. The electrode assemblies in the cell stack assembly are fixed with fixing tape. Examples of fixing tapes include, for example, an inner fixing tape wound in a peripheral direction around an outer peripheral face of the electrode assembly at the inner side of the laminate exterior packaging, and an outer fixing tape wound in the peripheral direction around an outer peripheral face of the laminate exterior packaging.

However, when wound with fixing tape, the overall thickness of the cell stack assembly also increases due to the increase in the thickness of the fixing tape, and there is room for improvement in volumetric efficiency.

In order to address this issue, in a cell stack assembly according to an exemplary embodiment of the present disclosure, the fixing tape is wound such winding positions of the fixing tapes do not overlap in the stacking direction for at least one pair of battery cells that are adjacent to each other. There would be an increase of two fixing tapes worth of thickness were the winding positions of the fixing tapes to overlap with each other in battery cells that are adjacent to each other. In contrast thereto, in the cell stack assembly according to an exemplary embodiment of the present disclosure, the winding positions of the fixing tapes do not overlap with each other for battery cells that are adjacent to each other, and the increased portion of the overall thickness of the cell stack assembly due to the fixing tapes can be suppressed. This enables the thickness of the cell stack assembly to be decreased by suppressing overlap of the fixing tapes, enabling volumetric efficiency to be raised, and enabling a higher energy density to be achieved.

Note that in the cell stack assembly according to an exemplary embodiment of the present disclosure, the fixing tapes may be wound such that the winding positions of the fixing tapes do not overlap in the stacking direction for at least one pair of battery cells that are adjacent to each other as stated above. However, preferably the fixing tapes are wound such that the winding positions of the fixing tapes do not overlap in the stacking direction for any battery cells that are adjacent to each other. Furthermore, more preferably the fixing tapes are wound such that the winding positions of the fixing tapes do not overlap in the stacking direction for any of the battery cells.

Description follows regarding an embodiment (a first embodiment) of a cell stack assembly according to an exemplary embodiment of the present disclosure, with reference to the drawings.

Each of the drawings referred to below are merely illustrated schematically, and the sizes and shapes of each portion are illustrated to facilitate understanding thereof, and are exaggerated as appropriate.

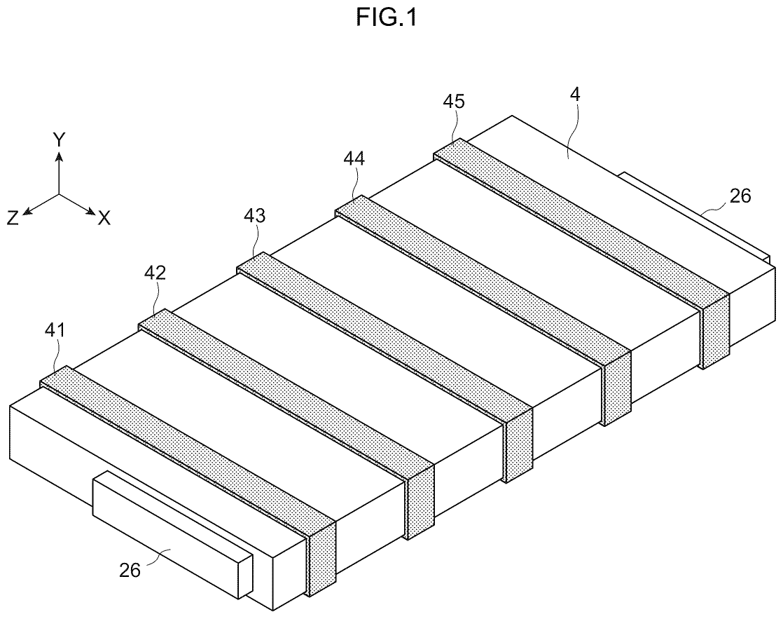

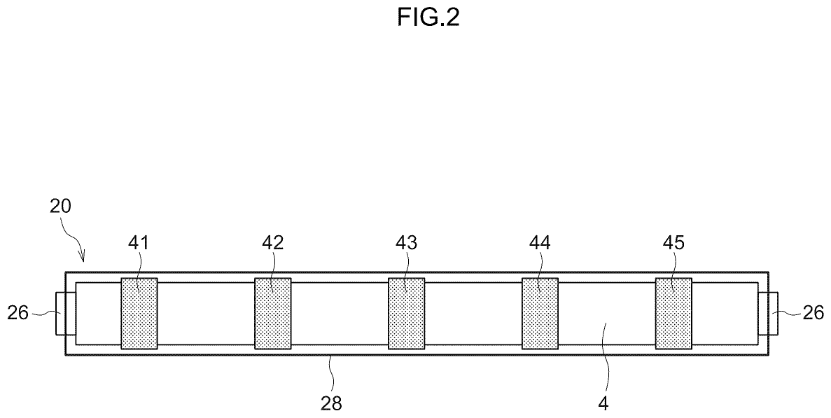

FIG. 1 is a schematic perspective view of a cell stack assembly according to the first embodiment, and illustrates a single electrode assembly and inner fixing tape. FIG. 2 is a schematic side view of the single electrode assembly and inner fixing tape illustrated in FIG. 1, illustrating the battery cell further enclosed by a laminate exterior packaging in a side view looking from a side face direction of the electrode assembly (the direction X in FIG. 1).

The electrode assembly 4 illustrated in FIG. 1 and FIG. 2 is formed in a substantially rectangular plate shape. Although not illustrated in the drawings, the electrode assembly 4 includes a cathode, an anode, and a separator interposed between the cathode and the anode. Note that the electrode assembly 4 may include a structure in which plural laminated structures, which each include a cathode, an anode, and a separator, are further stacked in an arrow Y direction (stacking direction).

The electrode assembly 4 includes respective terminals (tabs) 26 on length direction (arrow Z direction) side faces thereof. As an example in the present exemplary embodiment, the terminals 26 are provided at positions offset to one side from a center of a short direction (arrow X direction) of a battery cell 20.

There are 5 inner fixing tapes 41 to 45 disposed stuck so as to each be wound a full revolution around the outer peripheral face of the electrode assembly 4. Every one of the inner fixing tapes 41 to 45 is wound a full revolution onto the four faces of the electrode assembly 4 where the terminals 26 are not provided. In cases in which the electrode assembly 4 has a structure in which plural laminated structures, which each include a cathode, an anode, and a separator, are further stacked in the stacking direction (arrow Y direction), the plural laminated structures are bundled together by winding the inner fixing tapes 41 to 45 around the outer periphery thereof.

The electrode assembly 4 fixed by the five inner fixing tapes 41 to 45 is then, as illustrated in FIG. 2, covered by a lamination film 28, serving as an example of a laminate exterior packaging, and enclosed in the interior thereof. Note that FIG. 2 is a side view in which the interior of the lamination film 28 is depicted.

Note that FIG. 1 and FIG. 2 illustrate an embodiment in which the electrode assembly 4 is fixed by the five inner fixing tapes 41 to 45, however there is no limitation thereto, and the number of inner fixing tapes provided wound around a single electrode assembly 4 should be one or more.

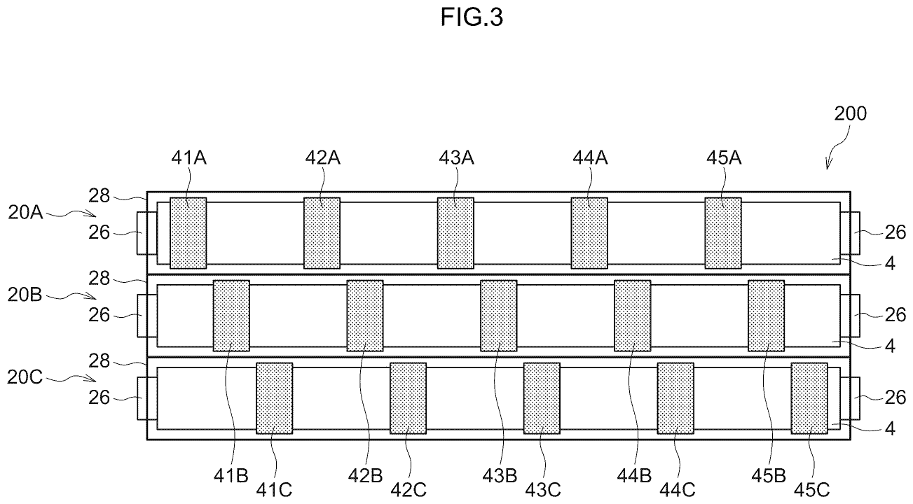

In the cell stack assembly according to the first embodiment, plural of the battery cells illustrated in FIG. 1 and FIG. 2 are further stacked as illustrated in FIG. 3. FIG. 3 is a schematic side view illustrating a cell stack assembly according to the first embodiment, and is a side view looking from a side face direction (X direction in FIG. 1) of the electrode assembly. Note that FIG. 3 is a side view in which the interiors of the lamination films are depicted.

As illustrated in FIG. 3, a cell stack assembly 200 includes a stacked structure of three battery cells 20A, 20B, 20C. The winding positions of the fixing tapes do not overlap in the stacking direction for all the battery cells that are adjacent to each other, namely the adjacent battery cell 20A and battery cell 20B, and the adjacent battery cell 20B and battery cell 20C. Specifically, the winding positions of the inner fixing tapes 41A, 42A, 43A, 44A, 45A of the adjacent battery cell 20A do not overlap in the stacking direction with the inner fixing tapes 41B, 42B, 43B, 44B, 45B of the adjacent battery cell 20B adjacent to the adjacent battery cell 20A. Moreover, the winding positions of the inner fixing tapes 41B, 42B, 43B, 44B, 45B of the adjacent battery cell 20B do not overlap in the stacking direction with the inner fixing tapes 41C, 42C, 43C, 44C, 45C of the adjacent battery cell 20C adjacent to the adjacent battery cell 20B.

Moreover, the respective winding positions of the fixing tapes do not overlap in the stacking direction for any the battery cells, namely between the battery cell 20A, the battery cell 20B, and the battery cell 20C. Specifically, the winding positions of all of the inner fixing tapes 41A, 42A, 43A, 44A, 45A of the adjacent battery cell 20A, the inner fixing tapes 41B, 42B, 43B, 44B, 45B of the battery cell 20B, the inner fixing tapes 41C, 42C, 43C, 44C, 45C of the battery cell 20C, do not overlap in the stacking direction.

This means that in the cell stack assembly 200 illustrated in FIG. 3, the increased portion in the overall thickness of the cell stack assembly due to the fixing tape can be suppressed. This thereby enables a reduction in the thickness of the cell stack assembly, enables the volumetric efficiency to be improved, and enables a higher energy density to be achieved.

Next, description follows regarding a different embodiment (a second embodiment) of the cell stack assembly according to an exemplary embodiment of the present disclosure, with reference to the drawings.

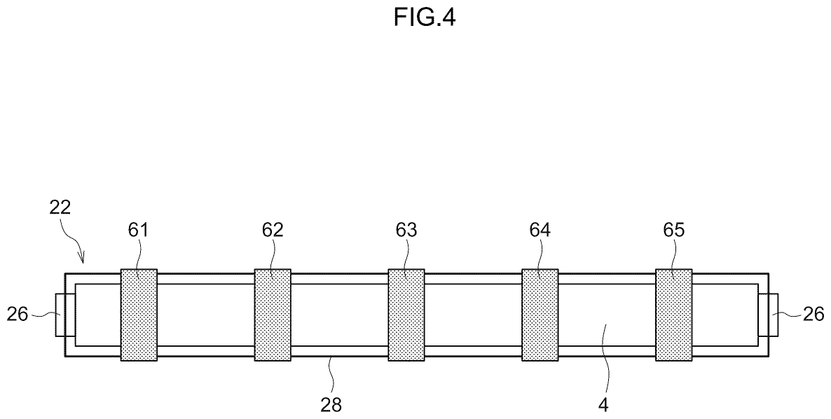

FIG. 4 is a schematic side view of a cell stack assembly according to a second embodiment, illustrating a battery cell in which a single electrode assembly and a laminate exterior packaging have been fixed by outer fixing tapes.

The electrode assembly 4 illustrated in FIG. 4 includes respective terminals (tabs) 26 on length direction side faces thereof. The electrode assembly 4 is then covered by the lamination film 28, serving as an example of a laminate exterior packaging, and enclosed in the interior thereof. Note that FIG. 4 is a side view in which an interior of the lamination film 28 is depicted.

Five outer fixing tapes 61 to 65 are disposed stuck to the electrode assembly 4 enclosed in the lamination film 28 so as to each be wound a full revolution on the outer peripheral face of the lamination film 28. Every one of the outer fixing tapes 61 to 65 is wound a full revolution onto the four faces of the lamination film 28 where the terminals 26 are not present.

Note that although FIG. 4 illustrates an embodiment in which the lamination film 28 has been fixed by the five outer fixing tapes 61 to 65, there is no limitation thereto, and the number of outer fixing tapes wound onto the lamination film 28 should be one or more.

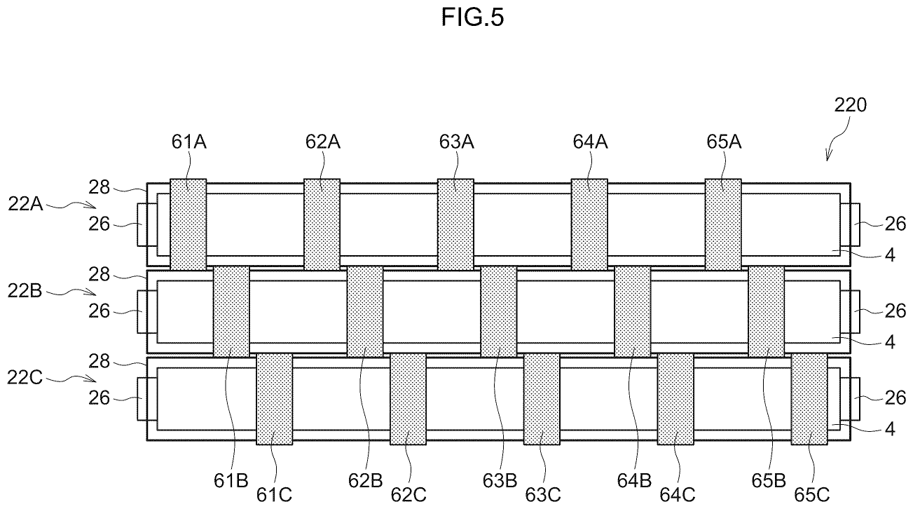

In the cell stack assembly according to the second embodiment, plural of the battery cell illustrated in FIG. 4 are stacked as illustrated in FIG. 5. FIG. 5 is a schematic side view illustrating a cell stack assembly according to the second embodiment, in a side view looking from a side face direction of the electrode assembly. Note that FIG. 5 is a side view in which interiors of lamination films are depicted.

As illustrated in FIG. 5, a cell stack assembly 220 includes a stacked structure of three battery cells 22A, 22B, 22C. The winding positions of the fixing tapes do not overlap in the stacking direction for all the battery cells that are adjacent to each other, namely between the adjacent battery cell 22A and battery cell 22B, and between the adjacent battery cell 22B and battery cell 22C. Specifically, the winding positions of the outer fixing tapes 61A, 62A, 63A, 64A, 65A of the battery cell 22A do not overlap in the stacking direction with the outer fixing tapes 61B, 62B, 63B, 64B, 65B of the battery cell 22B adjacent to the battery cell 22A. Moreover, the winding positions of the outer fixing tapes 61B, 62B, 63B, 64B, 65B of the battery cell 22B do not overlap in the stacking direction with the outer fixing tapes 61C, 62C, 63C, 64C, 65C of the battery cell 22C adjacent to the battery cell 22B.

Moreover, the winding positions of the fixing tapes do not overlap in the stacking direction for any the battery cells, namely between the battery cell 22A, the battery cell 22B, and the battery cell 22C. Specifically, all of the winding positions of the outer fixing tapes 61A, 62A, 63A, 64A, 65A of the battery cell 22A, the outer fixing tapes 61B, 62B, 63B, 64B, 65B of the battery cell 22B, and the outer fixing tapes 61C, 62C, 63C, 64C, 65C of the battery cell 22C, do not overlap in the stacking direction.

This means that in the cell stack assembly 220 illustrated in FIG. 5, the increased portion of the overall thickness of the cell stack assembly due to the fixing tapes can be suppressed. This thereby enables the overall thickness of the cell stack assembly to be reduced, raises the volumetric efficiency, and enables a higher energy density to be achieved.

Next, description follows regarding another embodiment (a third embodiment) of a cell stack assembly according to an exemplary embodiment of the present disclosure, with reference to the drawings.

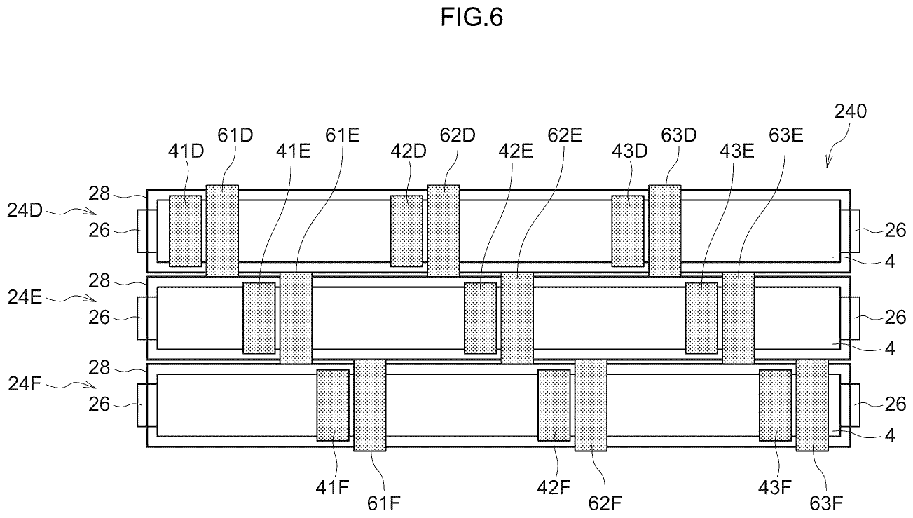

FIG. 6 is a schematic side view illustrating a cell stack assembly according to the third embodiment, in a side view looking from a side face direction of an electrode assembly. Note that FIG. 6 is a side view in which the interiors of the lamination films are depicted.

First description follows regarding a single battery cell 24D in a cell stack assembly 240 illustrated in FIG. 6. The electrode assembly 4 in the single battery cell 24D includes respective terminals (tabs) 26 on length direction side faces thereof. Three inner fixing tapes 41D to 43D are disposed stuck so as to each be wound a full revolution around the outer peripheral face of the electrode assembly 4. Every one of the inner fixing tapes 41D to 43D is wound a full revolution around the four faces of the electrode assembly 4 where the terminals 26 are not provided.

The electrode assembly 4 fixed by the three inner fixing tapes 41D to 43D is then covered by a lamination film 28 serving as an example of a laminate exterior packaging and enclosed in the interior thereof. Furthermore, three outer fixing tapes 61D to 63D are disposed stuck to the electrode assembly 4 enclosed in the lamination film 28 so as to be wound a full revolution around the outer peripheral face of the lamination film 28. Every one of the outer fixing tapes 61D to 63D is wound a full revolution around the four faces of the lamination film 28 where the terminals 26 are not present.

Namely, the battery cell 24D is fixed by the inner fixing tapes 41D to 43D wound directly onto the outer peripheral face of the electrode assembly 4, and by the outer fixing tapes 61D to 63D wound onto the outer peripheral face of the lamination film 28.

Note that although the battery cells 24D, 24E, 24F illustrated in FIG. 6 are each illustrated for an embodiment fixed by three inner fixing tapes and three outer fixing tapes, there is no limitation thereto. The number of inner fixing tapes wound around a single electrode assembly 4 may be one or more, and also the number of outer fixing tapes wound around the lamination film 28 should be one or more.

The cell stack assembly 240 according to the third embodiment includes a stacked structure of three battery cells 24D, 24E, 24F. The winding positions of the fixing tapes do not overlap in the stacking direction for any of the battery cells that are adjacent to each other, namely between the adjacent battery cell 24D and battery cell 24E, and between the adjacent battery cell 24E and battery cell 24F. Specifically, the winding positions of the inner fixing tapes 41D, 42D, 43D and the outer fixing tapes 61D, 62D, 63D of the battery cell 24D do not overlap in the stacking direction with the winding positions of the inner fixing tapes 41E, 42E, 43E and the outer fixing tapes 61E, 62E, 63E of the battery cell 24E adjacent to the battery cell 24D. Moreover, the winding positions of the inner fixing tapes 41E, 42E, 43E and the outer fixing tapes 61E, 62E, 63E of the battery cell 24E do not overlap in the stacking direction with the winding positions of the inner fixing tapes 41F, 42F, 43F and the outer fixing tapes 61F, 62F, 63F of the battery cell 24F adjacent to the battery cell 24E.

Moreover, the winding positions of the fixing tapes do not overlap in the stacking direction for any battery cells, namely between the adjacent battery cell 24D, the battery cell 24E, and the battery cell 24F. Specifically, winding positions do not overlap in the stacking direction for any of the inner fixing tapes 41D, 42D, 43D and the outer fixing tapes 61D, 62D, 63D of the battery cell 24D, the inner fixing tapes 41E, 42E, 43E and the outer fixing tapes 61E, 62E, 63E of the battery cell 24E, and the inner fixing tapes 41F, 42F, 43F and the outer fixing tapes 61F, 62F, 63F of the battery cell 24F.

This means that in the cell stack assembly 240 illustrated in FIG. 6, the increased portion of the overall thickness of the cell stack assembly due to the fixing tape can be suppressed. This thereby enables the thickness of the cell stack assembly to be decreased, raises the volumetric efficiency, and enables a higher energy density to be achieved.

Note that in the cell stack assembly 240 illustrated in FIG. 6, for the single battery cell 24D, the winding positions of the inner fixing tapes 41D, 42D, 43D do not overlap with the winding positions of the outer fixing tapes 61D, 62D, 63D. Similarly, for the single battery cell 24E, the winding positions of the inner fixing tapes 41E, 42E, 43E do not overlap with the winding positions of the outer fixing tapes 61E, 62E, 63E, and furthermore, for the single battery cell 24F, the winding positions of the inner fixing tapes 41F, 42F, 43F do not overlap with the winding positions of the outer fixing tapes 61F, 62F, 63F.

This means that in the cell stack assembly 240 illustrated in FIG. 6, the increased portion of the overall thickness of the cell stack assembly due to the winding positions of the inner fixing tapes and the outer fixing tapes of a single battery cell can be suppressed. This thereby enables the thickness of the cell stack assembly to be reduced, raises the volumetric efficiency, and enables a higher energy density to be achieved.

Although the cell stack assembly of the first embodiment illustrated in FIG. 3, the cell stack assembly of the second embodiment illustrated in FIG. 5, and the cell stack assembly of the third embodiment illustrated in FIG. 6, all illustrate embodiments in which the winding positions of the fixing tapes do not overlap in the stacking direction for any of the battery cells, there is no limitation thereto. For example, a configuration may be adopted in which the winding positions of the fixing tapes do not overlap in the stacking direction for any of the battery cells that are adjacent to each other, and the winding positions of the fixing tapes do overlap in the stacking direction for some of the non-adjacent battery cells.

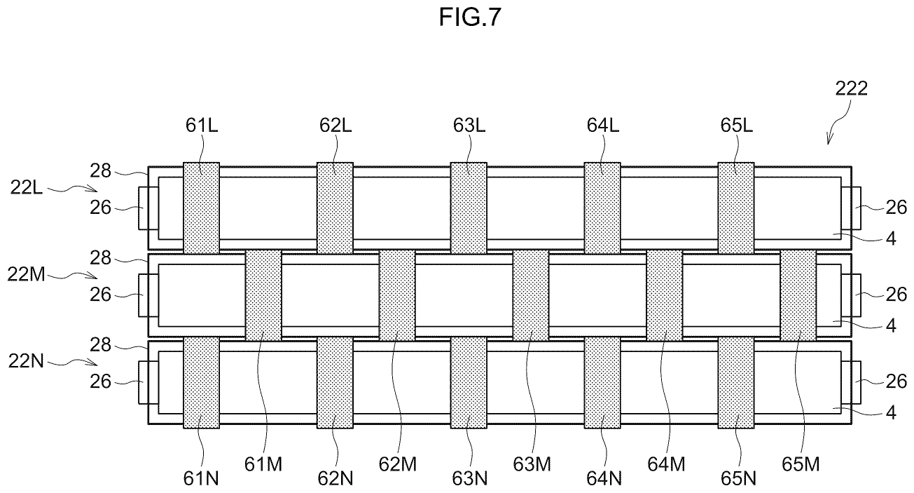

For example, a cell stack assembly 222 illustrated in FIG. 7 includes a stacked structure of three battery cells 22L, 22M, 22N. The winding positions of the fixing tapes do not overlap in the stacking direction for any of the battery cells that are adjacent to each other, namely between the adjacent battery cell 22L and battery cell 22M, and between the adjacent battery cell 22M and battery cell 22N. Specifically, the winding positions of the outer fixing tapes 61L, 62L, 63L, 64L, 65L of the battery cell 22L do not overlap in the stacking direction with the outer fixing tapes 61M, 62M, 63M, 64M, 65M of the battery cell 22M adjacent to the battery cell 22L. Moreover, the winding positions of the outer fixing tapes 61M, 62M, 63M, 64M, 65M of the battery cell 22M do not overlap in the stacking direction with the outer fixing tapes 61N, 62N, 63N, 64N, 65N of the battery cell 22N adjacent to the battery cell 22M. However, the winding positions of the outer fixing tapes 61L, 62L, 63L, 64L, 65L of the battery cell 22L do overlap in the stacking direction with the winding positions of the outer fixing tapes 61N, 62N, 63N, 64N, 65N of the battery cell 22N that is non-adjacent to the battery cell 22L.

As illustrated in FIG. 7, by adopting a configuration in which the winding positions of the fixing tapes do not overlap in the stacking direction for all the battery cells that are adjacent to each other, the increased portion of the overall thickness of the cell stack assembly due to the fixing tapes can be suppressed. This thereby enables the thickness of the cell stack assembly to be reduced, raises the volumetric efficiency, and enables a higher energy density to be achieved.

Moreover, although the cell stack assembly of the first embodiment illustrated in FIG. 3, the cell stack assembly of the second embodiment illustrated in FIG. 5, and the cell stack assembly of the third embodiment illustrated in FIG. 6, all illustrate examples of stacked cell stack assemblies configured by three battery cells, there is no limitation thereto. For example, the number of battery cells stacked in a cell stack assembly should be two or more, and there may be 10 or more stacked battery cells, and there may also be 20 or more stacked battery cells.

In each of these cases too, the fixing tapes are wound such that winding positions of the fixing tapes do not overlap in the stacking direction for at least one pair of battery cells that are adjacent to each other. Note that preferably the fixing tapes are wound such that the winding positions of the fixing tapes do not overlap in the stacking direction for all the battery cells that are adjacent to each other. Furthermore, more preferably the fixing tapes are wound such that the winding positions of the fixing tapes do not overlap in the stacking direction for any of the battery cells.

Next, description follows regarding a battery module, a battery pack, and a vehicle including a cell stack assembly according to an exemplary embodiment of the present disclosure.

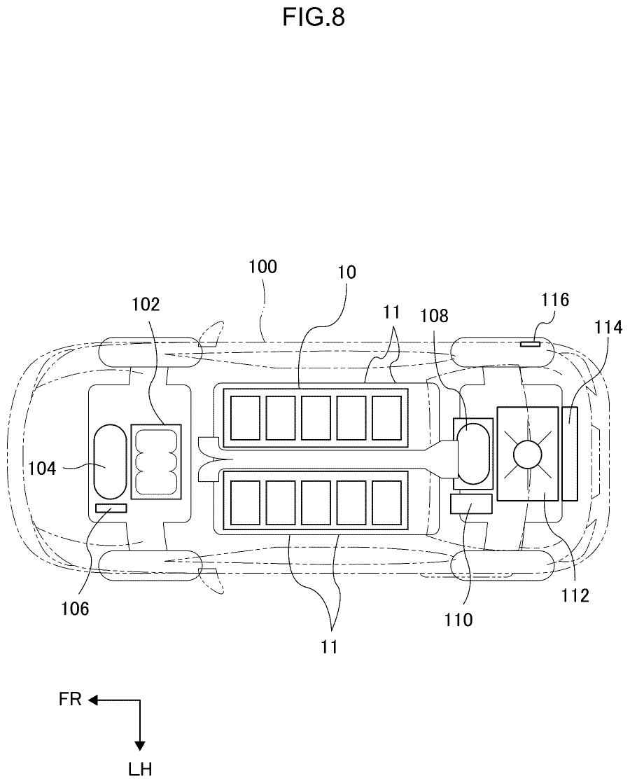

FIG. 8 is a schematic plan view illustrating relevant portions of a vehicle 100 applied with a battery pack 10 according to an exemplary embodiment. As illustrated in FIG. 8, the vehicle 100 is a battery electric vehicle (BEV) with the battery pack 10 installed below the floor thereof. Note that arrow UP, arrow FR, and arrow LH in each of the drawings indicate, respectively, upward in a vehicle height direction, forward in a vehicle front-rear direction, and leftward in a vehicle width direction. Unless explicitly stated otherwise, directions of front and rear, left and right, and up and down as used in the following explanation respectively indicate front and rear in a vehicle front-rear direction, left and right in a vehicle width direction, and up and down in a vehicle height direction.

As an example of the vehicle 100 of the present exemplary embodiment, a DC/DC converter 102, an electric compressor 104, and a positive temperature coefficient (PTC) heater 106 are disposed further toward the vehicle front side than the battery pack 10. A motor 108, a gear box 110, an inverter 112, and a charger 114 are disposed further toward the vehicle rear side than the battery pack 10.

Direct current output from the battery pack 10 is regulated in voltage by the DC/DC converter 102, and then supplied to the electric compressor 104, the PTC heater 106, the inverter 112, and the like. Rear wheels are rotated by power being supplied to the motor 108 through the inverter 112 to cause the vehicle 100 to travel.

A charging port 116 is provided at a right side portion of a rear section of the vehicle 100, and power from the charging port 116 can accumulate in the battery pack 10 through the charger 114 by being connected to a charging plug of a non-illustrated external charging facility.

Note that the placement, structure, and the like of each component configuring the vehicle 100 are not limited to the configuration described above. For example, application may be made to a hybrid vehicle (HV), or to a plug-in hybrid electric vehicle (PHEV), installed with an engine. Moreover, although the present exemplary embodiment is for a rear-wheel drive vehicle in which the motor 108 is installed to a rear section of the vehicle, there is no limitation thereto, and application may be made to a front-wheel drive vehicle in which the motor 108 is installed to a front section of the vehicle, or a pair of the motors 108 may be installed at the front and rear of the vehicle. Furthermore, application may be made to a vehicle including an in-wheel motor for each wheel.

The battery pack 10 in this case is configured including plural battery modules 11. As an example, in the present exemplary embodiment there are ten of the battery modules 11 provided. Specifically, five of the battery modules 11 are arrayed in the vehicle front-rear direction along the right side of the vehicle 100, and five of the battery modules 11 are arrayed in the vehicle front-rear direction along the left side of the vehicle 100. The respective battery modules 11 are connected together electrically.

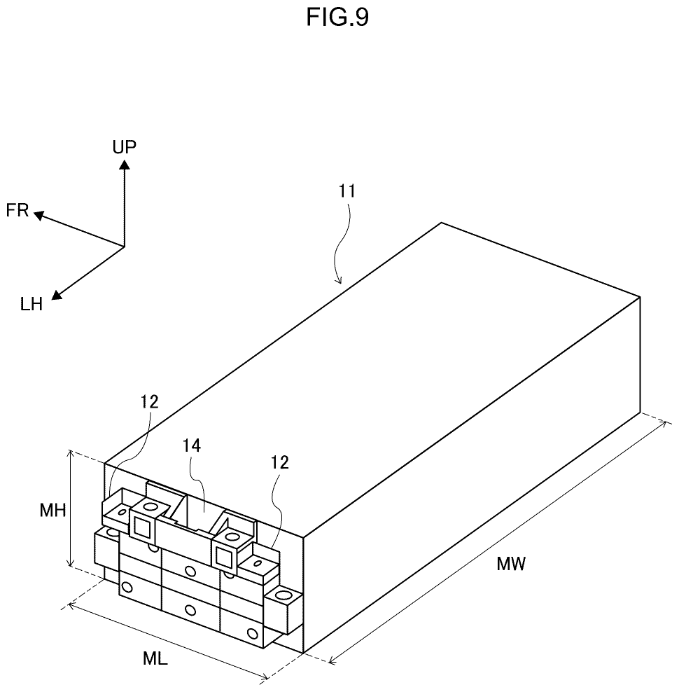

FIG. 9 is a schematic perspective view of the battery module 11. As illustrated in FIG. 9, the battery module 11 is formed in a substantially cuboidal shape having a length direction along the vehicle width direction. An outer shell of the battery module 11 is formed from an aluminum alloy. For example, an outer shell of the battery module 11 is formed by joining die-cast aluminum together at both edges of an extruded member made from aluminum alloy using laser welding or the like.

A pair of voltage terminals 12 and a connector 14 are respectively provided at each of the two vehicle width direction end portions of the battery module 11. A flexible printed circuit 22, described later, is connected to the connectors 14. A non-illustrated busbar is welded to each of the two vehicle width direction end portions of the battery module 11.

A vehicle width direction length MW of the battery module 11 is, for example, from 350 mm to 600 mm, a vehicle front-rear direction length ML is, for example, from 150 mm to 250 mm, and a vehicle height direction height MH is, for example, from 80 mm to 110 mm.

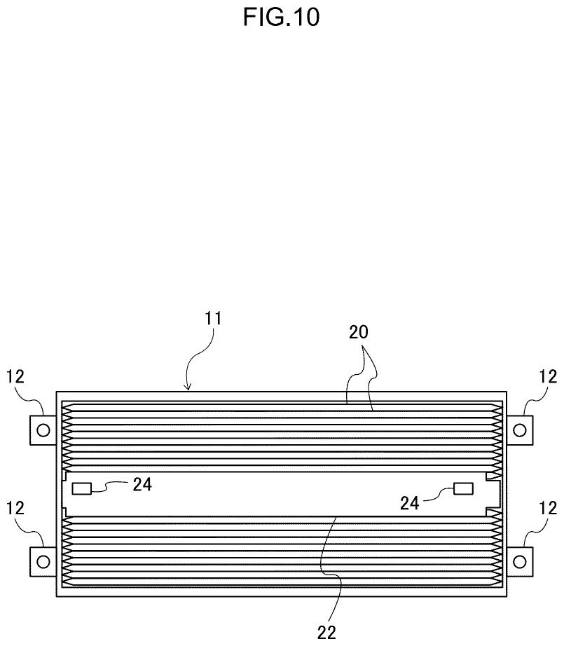

FIG. 10 is a plan view of a state in which a lid of the battery module 11 has been removed. As illustrated in FIG. 10, plural battery cells 20 are housed in an arrayed state inside the battery module 11. As an example of the present exemplary embodiment, 24 of the battery cells 20 are arrayed along the vehicle front-rear direction and adhered to each other.

The flexible printed circuit 22 is disposed above the battery cells 20. The flexible printed circuit 22 is formed in a band shape having a length direction along the vehicle width direction, with a thermistor 24 provided at each of the two end portions of the flexible printed circuit 22. The thermistors 24 are not adhered to the battery cells 20, and are configured so as to be pressed toward the battery cell 20 side by the lid of the battery module 11.

Moreover, one or plural pieces of non-illustrated shock absorption material is/are housed inside the battery module 11. For example, the shock absorption material may be a thin sheet shaped member capable of elastic deformation and having a thickness direction along the array direction of the battery cells 20, with the shock absorption material disposed between the battery cells 20 that are adjacent to each other. As an example of the present exemplary embodiment, respective pieces of shock absorption material are disposed at the two length direction end portions of the battery module 11, and at a length direction central portion thereof.

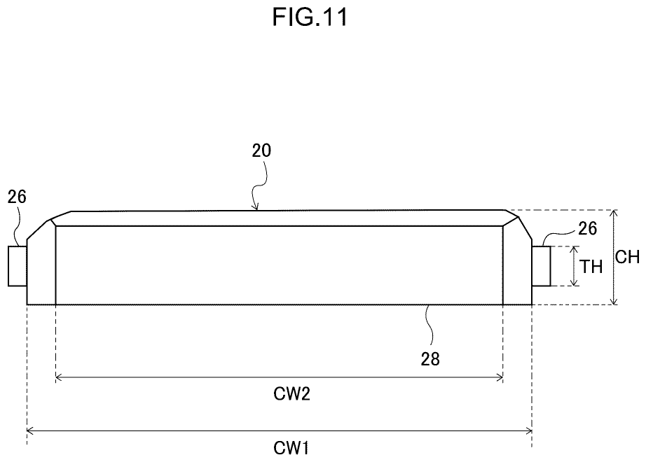

FIG. 11 is a schematic diagram of the battery cell 20 housed in the battery module 11 viewed along the thickness direction of the battery cell 20. As illustrated in FIG. 11, the battery cell 20 is formed in a substantially rectangular plate shape, and a non-illustrated electrode assembly is housed in the interior thereof. The electrode assembly is configured by a lamination of a cathode, an anode, and a separator, sealed by a lamination film 28.

As an example of the present exemplary embodiment, a housing section of the electrode assembly is formed by folding and sticking the lamination film 28 that has an embossed sheet shape. Note that although both a single cup embossed structure embossed in one location, and a double cup embossed structure embossed in two locations, may be adopted, the present exemplary embodiment is a single cup embossed structure having a draw depth of from about 8 mm to about 10 mm.

Upper ends at the two length direction end portions of the battery cell 20 are bent over an angular external profile. Moreover, upper end portions of the battery cell 20 are also bent over.

Respective terminals (tabs) 26 are provided at the two length direction end portions of the battery cell 20. As an example of the present exemplary embodiment, the terminals 26 are provided at positions offset downward from a height direction center of the battery cell 20. The terminals 26 are joined to the respective non-illustrated busbar by laser welding or the like.

A vehicle width direction length CW1 of the battery cell 20 is, for example, from 530 mm to 600 mm, from 600 mm to 700 mm, from 700 mm to 800 mm, from 800 mm to 900 mm, or 1000 mm or over, a length CW2 of a region housing the electrode assembly is, for example, from 500 mm to 520 mm, from 600 mm to 700 mm, from 700 mm to 800 mm, from 800 mm to 900 mm, or 1000 mm or over, and a height CH of the battery cell 20 is, for example, from 80 mm to 110 mm, or from 110 mm to 140 mm. The thickness of the battery cell 20 is from 5.0 mm to 7.0 mm, from 7.0 mm to 9.0 mm, or from 9.0 mm to 11.0 mm, and a height TH of the terminals 26 is from 40 mm to 50 mm, from 50 mm to 60 mm, or from 60 mm to 70 mm.

What is claimed is:

1. A cell stack assembly, comprising:
a plurality of stacked battery cells, each including:
an electrode assembly;
a laminate exterior packaging that covers the electrode assembly and encloses the electrode assembly internally; and
a fixing tape, comprising at least one of an inner fixing tape wound in a peripheral direction onto an outer peripheral face of the electrode assembly at an inner side of the laminate exterior packaging, or an outer fixing tape wound in a peripheral direction onto an outer peripheral face of the laminate exterior packaging, wherein:
taking a direction in which the plurality of battery cells are stacked as a stacking direction,
the fixing tape is wound such that winding positions of the fixing tape do not overlap in the stacking direction for at least one adjacent pair of the battery cells.

2. The cell stack assembly of claim 1, wherein:
the fixing tape comprises only the inner fixing tape; and
the inner fixing tape is wound such that winding positions of the inner fixing tape do not overlap in the stacking direction for at least one adjacent pair of the battery cells.

3. The cell stack assembly of claim 1, wherein:
the fixing tape comprises only the outer fixing tape; and
the outer fixing tape is wound such that winding positions of the outer fixing tape do not overlap in the stacking direction for at least one adjacent pair of the battery cells.

4. The cell stack assembly of claim 1, wherein:
the fixing tape comprises the inner fixing tape and the outer fixing tape; and
the inner fixing tape and the outer fixing tape are wound such that winding positions of the inner fixing tape and winding positions of the outer fixing tape do not overlap in the stacking direction for at least one adjacent pair of the battery cells.

5. The cell stack assembly of claim 4, wherein the fixing tape is wound such that winding positions of the inner fixing tape and winding positions of the outer fixing tape do not overlap in a single battery cell of the battery cells.

6. The cell stack assembly of claim 1, wherein the fixing tape is wound such that the winding positions of the fixing tape do not overlap in the stacking direction for any of the battery cells that are adjacent to each other.

7. The cell stack assembly of claim 6, wherein the fixing tape is wound such that the winding positions of the fixing tape do not overlap in the stacking direction for any the battery cells.

8. A battery module, comprising a cell stack assembly of claim 1.
